(19) United States
(12) Patent Application Publication
(10) Pub. No.: US 2011/0013009 A1
(43) Pub. Date: Jan. 20, 2011

(54) REFLECTION MICROSCOPE FOCUSING

(75) Inventors: Romain Ramel, Saint Egreve (FR); Benoît Taeymans, Grenoble (FR); Mickaël Postolovic, Saint Egreve (FR)

Correspondence Address: Vedder Price P.C., 875 15th Street NW, Suite 725, Washington, DC, 20005, US

(73) Assignee: VIT, Saint Egreve (FR)

(21) Appl. No.: 12/812,766

(22) PCT Filed: Sep. 28, 2009
(86) PCT No.: PCT/FR2009/051830

§ 371 Date: Oct. 5, 2010

(30) Foreign Application Priority Data
Sep. 29, 2008 (FR) 0856528

(51) Int. Cl. H04N 7/18; G06K 9/40

(52) U.S. Cl. 348/79; 382/255; 348/E07.085

(57) ABSTRACT

The invention relates to a method of focusing, by an imaging device, of images of a substantially planar surface of an object including the step of determining the attitude of the surface of the object with respect to a reference plane by scanning this surface by means of at least one triangulation sensor along exactly two parallel lines in the reference plane. The invention further includes the steps of splitting the surface of the object into areas of a size corresponding to the size of a taken image, inferring from the attitude respective elevations of the image areas, and adjusting, for each area, the focus with respect to the elevation thereof.

### FIELD OF THE INVENTION

The present invention generally relates to imaging installations and, more specifically, to a reflection microscope installation and to the focusing of this microscope on image taking areas.

The present invention also relates to the determination of the attitude or tilt of a substantially planar surface of an object with respect to a reference plane.

The present invention more specifically applies to electronic microcircuit line scan installations exploiting images taken by a microscope equipped with a digital camera.

### DISCUSSION OF PRIOR ART

FIG. 1 schematically shows an installation of the type to which the present invention applies as an example. Objects O are placed on a conveyor 1 of a image line scan processing installation comprising a reflection microscope 2 equipped with a digital camera, connected to an image processing computer system 3. Conveyor 1 or microscope 2 is likely to move in a plane XY (generally horizontal), perpendicular to the optical axis (generally vertical) of the microscope, to take images by scanning of the surface of objects O.

In the applications more specifically targeted by the present invention, the objects to be analyzed generally have a size greater than illumination area IA, and thus than the microscope image taking area. The surface of each object to be analyzed is thus scanned by image taking area and the image is restored by digital processing.

Even if the surface of the objects to be processed is substantially planar, it may be tilted with respect to a plane perpendicular to the optical axis of the microscope. According to the depth of focus of the microscope lens, it may be necessary to adjust the focusing from one area to another. The focusing comprises displacing the microscope optics to adjust the distance with respect to the surface of the object.

A conventional technique comprises using a sensor exploiting a portion of each viewing area and taking several images by means of this sensor with different focuses. The image portion having the greatest contrast, which corresponds to the clearest image, is then determined. A disadvantage of such a method is that, for each focusing point (and thus for each area), it requires acquiring several images (on the order of ten) and processing them. The required time is often incompatible with industrial application efficiency requirements.

Automated focusing systems which use a measurement by infrared radiation to assess the distance between the lens of the imaging device and the object are also known. An emitting cell sends one or several infrared beams onto the object and a receiving cell analyses the beam sent back by the object. This type of automated focusing is poorly adapted to images with a high contrast.

It would be desirable to have a system for adjusting the focus of an imaging device compatible with the rates desired in industrial applications.

An example of application of the present invention relates to the scanning of microelectronic circuits (semiconductor chips, microelectromechanical structures (MEMS), etc.), for example, to detect the presence of impurities on these circuits. The circuits to be analyzed are generally assembled in packages, open at their upper surface, and positioned on batch processing cradles or rails. The quality of the detection depends on the quality of the images. Now, the assembly tolerances of electronic or electromechanical chips generate attitude variations of the chips with respect to the horizontal direction.

It would be desirable to have a focusing system specifically adapted to installations for analyzing electronic circuits by image processing, where the attitude variations of the circuits to be analyzed risk altering the analysis.

It is also needed, independently from any imaging, to determine the attitude of a substantially planar surface of an object with respect to a reference plane, in particular of a microelectronic chip in its package, for example, for quality control purposes.

In a batch processing process where the circuits to be tested are successively presented under the imaging device, it may further be useful to determine the respective positions of the chips in advance to avoid taking images of useless regions (outside of the chips).

Document US-A-2003/053676 describes a system for detecting defects on integrated circuit wafers by image analysis. This document provides to create a focus mapping by scanning of a chip. The obtained mapping provides a distribution of the detected elevations. This mapping is used to focus the microscope on the concerned areas. The large number of necessary measurement points adversely affects the processing speed.

Document US-A-2002/0131167 describes a sample carrier for a microscope, capable of being adjusted in terms of tilting to keep the sample horizontal, where the microscope focusing is not modified.

U.S. Pat. No. 5,714,756 provides the focusing of an optical device based on measurements at three different points of a surface to determine the tilt thereof.

Document JP-A-59074515 provides performing a focusing at different locations of a surface.

### SUMMARY OF THE INVENTION

The present invention aims at overcoming all or part of the disadvantages of usual automated focusing systems.

An embodiment of the present invention more specifically aims at providing a solution faster than systems of focusing by contrast analysis.

An embodiment of the present invention also aims at a solution compatible with the measurement of the tilt, with respect to a reference plane, of a substantially planar surface of an object.

An embodiment of the present invention aims at a solution particularly adapted to the line scanning of objects to be analyzed by a reflection microscope.

To achieve all or part of these objects, the present invention provides a method of focusing, by an imaging device, of images of a substantially planar surface of an object, comprising the steps of:

determining the attitude of the surface of the object with respect to a reference plane by scanning this surface by means of at least one triangulation sensor along exactly two parallel lines in the reference plane;

splitting the surface of the object into areas of a size corresponding to the size of a taken image;

inferring from the attitude respective elevations of the image areas; and

adjusting, for each area, the focus with respect to the elevation thereof.

According to an embodiment of the present invention, the attitude is determined from two profiles representative of the elevations of the surface with respect to the reference plane.

According to an embodiment of the present invention, a laser beam of the sensor is normal to the reference plane.

According to an embodiment of the present invention, said lines are parallel to a direction of line processing of a batch of objects.

According to an embodiment of the present invention, the resolution of the sensor is selected to be smaller than the depth of focus of the imaging device.

According to an embodiment of the present invention, the diameter of the spot created by a laser beam of the sensor at the surface of the object is selected to be of the same order of magnitude as the smallest dimension of patterns on the object.

The present invention also provides an object imaging installation for an analysis by image processing comprising:

a reflection microscope with a settable depth of focus, equipped with a digital camera;

a conveyor of the objects in a reference plane perpendicular to the optical axis of the microscope;

a device for determining the attitude of each object with respect to the reference plane; and

a system for interpreting the attitude to focus said microscope.

According to an embodiment of the present invention, the attitude determination device comprises two triangulation sensors aligned in a direction perpendicular to the scanning direction.

### BRIEF DESCRIPTION OF THE DRAWINGS

The foregoing and other objects, features, and advantages of the present invention will be discussed in detail in the following non-limiting description of specific examples in connection with the accompanying drawings, among which:

FIG. 1, previously described, is a simplified representation of a reflection microscope installation of the type to which the present invention applies as an example;

FIG. 2 is a simplified cross-section view of a packaged microelectronic chip capable of forming an object to be photographed;

FIG. 3 is a top view of the chip of FIG. 2;

FIG. 4 is a simplified representation of an attitude determination device illustrating the operation of a triangulation sensor;

FIG. 5 illustrates a mode of determination of the diameter of the beam of a triangulation sensor of the attitude determination device;

FIG. 6 is a simplified representation of an embodiment of an imaging installation;

FIG. 7 is a partial simplified perspective view of an embodiment of an attitude determination device equipping the installation of FIG. 6;

FIG. 8A is a simplified perspective view of a packaged microelectronic chip;

FIG. 8B shows examples of elevation profiles obtained by means of the device of FIG. 6; and

FIG. 9 is a block diagram illustrating different steps of an imaging device using the installation of FIG. 6.

The same elements have been designated with same reference numerals in the different drawings, which have been drawn out of scale.

### DETAILED DESCRIPTION

For clarity, only those elements and steps which are useful to the understanding of the invention have been shown and will be described. In particular, the exploitation of the views by the image processing system has not been detailed, the invention being compatible being compatible with usual processings. Further, the imaging devices and their assembly in a line scan processing installation have not been detailed either, the invention being here again compatible with current microscopes and installations.

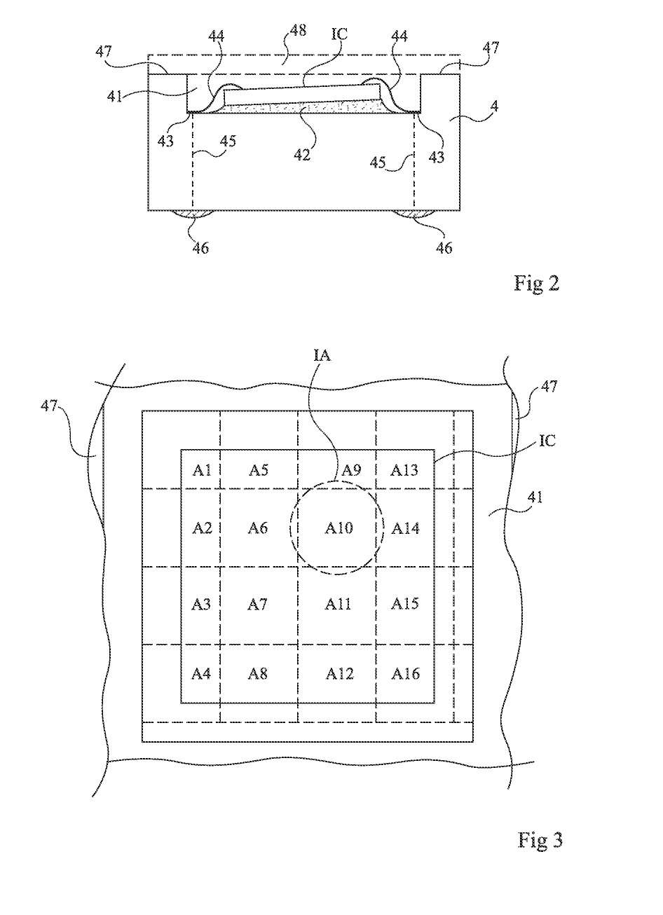

FIG. 2 is a cross-section view of an integrated circuit chip IC assembled in a package 4 (for example, made of ceramic) and intended to be analyzed by an image processing installation. Chip IC is placed on the bottom of a cavity 41 defined by package 4. Typically, the chip is glued (glue layer 42) by its rear (lower) surface and front (upper) surface contacts of the chip are generally connected to contacting areas 43 for conductive wires 44. The contacting areas are connected, for example, by vias 45, to connection terminals 46, for example, at the lower surface of the package. At the end of the manufacturing, a cap 48 (shown in dotted lines) is generally placed on the package, to rest on a peripheral edge 47 delimiting cavity 41. As a variation (for example, for a chip having no electromechanical structures), cavity 41 is filled with resin. The analysis by image processing is performed before package 4 is closed.

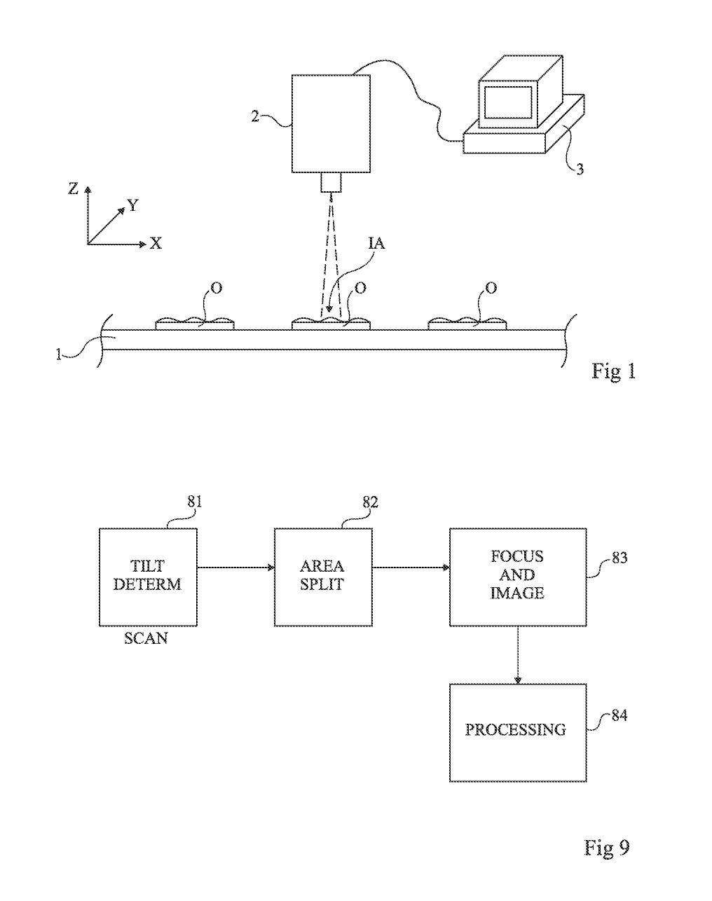

For a reflection microscope processing, the chip surface is generally split into areas according to the size of the taken images, which generally corresponds to illumination area IA (FIG. 1) of the microscope.

FIG. 3 illustrates an example of a splitting into areas (for example sixteen areas A1 to A16) of the surface of a chip IC. The areas are successively scanned by the reflection microscope. In practice, and as in any image restoring process based on several takes, a slight overlapping between areas is provided.

According to a specific example, package 4 has a generally rectangular cuboid shape with a side of several millimeters (for example, between 5 and 15 mm) and a height of a few millimeters (for example, 2 or 3 mm). The depth of cavity 41 is on the order of a few millimeters (for example, approximately 2 mm). The chip thickness is of a few hundreds of micrometers (for example, from approximately 200 to 800 μm). The surface unevennesses (the roughness) of the chip are of a few micrometers (for example, smaller than 10 μm). The peripheral distance between chip IC and the edges of cavity 41 is of several hundreds of micrometers (for example, on the order of 1 mm). The width of peripheral edges 47 limiting cavity 41 is of a few hundreds of micrometers (for example, on the order of 500 μm). Glue layer 42 has a thickness of several tens of micrometers (for example, on the order of 50 μm).

The depth of focus of the microscope is generally selected according to the roughness of the processed surface, to obtain an exploitable image. In the above example, the depth of focus is of a few tens of micrometers (for example, between 20 and 40 micrometers).

In practice and as illustrated in FIG. 2, the glue may often be unevenly crushed on assembly of chip IC. The chip attitude then is not horizontal, but tilted with respect to the bottom of package 4. This lack of horizontality may generate, according to the chip areas, elevation variations greater than the surface unevennesses which are desired to be measured, or even greater than the depth of focus of the microscope. It is thus necessary to focus the microscope optics according to areas.

More generally, a focusing is required for an object having a substantially planar surface photographed, when the tilt thereof generates, from one point of its surface to another, an elevation variation greater than the unevennesses which are desired to be detected by the image processing, or even greater than the depth of focus of the microscope. “Substantially planar” means that the surface to be photographed has a surface unevenness corresponding to less than ten times the requested angular tolerance, that is, that all the surface points are comprised between two parallel planes, distant by at least ten times this angular tolerance relative to the surface.

The inventors provide determining the chip attitude with respect to a reference plane to infer therefrom, for each imaging area, the microscope focusing.

Knowing the attitude may also help, independently from any imaging, verifying that manufacturing tolerances are respected. For example, for electromechanical structures, the chip attitude in its package must frequently respect be relatively horizontal (for example, with less than a few tenths of a tilt degree).

To determine the attitude, laser triangulation sensors are used. These sensors emit a laser beam towards the target (chip area to be scanned) and assess a distance variation based on the offset of a reflection sensed by a photodetector bar with respect to a reference position. A variation of the distance from the target to the sensor translates as a variation of the angle according to which the sensor receives the light, and thus photodetector pixels which are excited.

Triangulation sensors emitting a laser beam (for example, in the visible red) and detecting a reflection of this beam by means of a charge transfer device (CCD) are known per se. Such sensors are often used to detect displacements. Sensors of this type are sold, for example, by companies Keyence and Senso-Part.

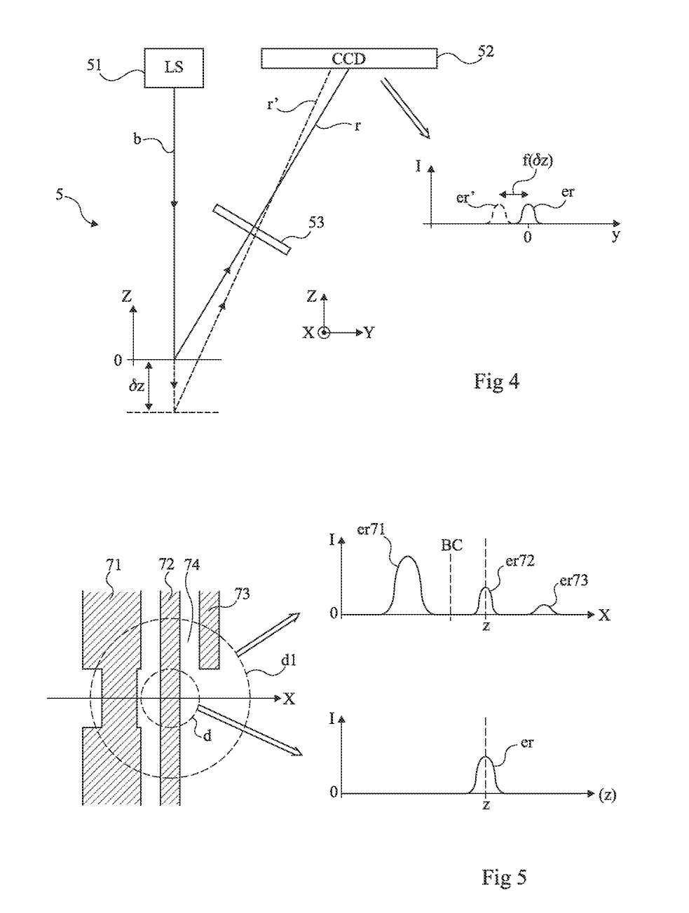

FIG. 4 is a simplified representation of a triangulation sensor 5 used for an elevation measurement (axis Z). Such a sensor 5 comprises a light source 41, typically a laser source (LS), having its radius “b” directed towards the surface for which the elevation relative to a reference plane is desired to be measured. Reflection “r” of the laser beam on the target is analyzed by a charge transfer sensor 52 (CCD) after having crossed an optical system 53. The electric response of the sensor is analyzed by a calculator (for example, the computer system of the installation, not shown in FIG. 4) which analyzes intensity I of the light beam received by the sensor on its different pixels, the pixels which are not illuminated by laser beam b corresponding, by convention, to a zero intensity. Electric response “er” at the illumination point has a Gaussian shape with a maximum value corresponding, for a homogeneous reflective surface, to the center of laser beam b. An elevation variation δz between reference position 0 and sensor 52 translates as a variation of the angle of observation of reflected beam “r”, and thus as a displacement f(δz) of response peak “er” on the CCD bar.

The axis of beam b and the optical axis of the detector (sensor 52+optics 53) are in a vertical plane, preferably parallel to axis Y. The angular position of bar 52 is not critical.

Preferably, laser beam b is normal to the horizontal reference plane. Accordingly, an elevation difference δz translates as a distance f(δz) between the maximum values of the light intensity er and er′ sensed by bar 42, which only depends on elevation difference δz. The interpretation of the measurements is thus made easier than in a solution where the incident beam would be tilted with respect to the direction perpendicular to the reference plane, whereby the distance between the respective maximum values sensed by the bar would not only depend on elevation difference δz, but also on a horizontal offset depending on the tilt of the incident beam.

A difficulty linked to the use of a triangulation sensor for the elevation measurement is due to the lack of homogeneity of reflections. This results in a specific selection of the laser beam diameter (and thus of the size of the spot on the object). This problem is especially present for electronic chips having a generally inhomogeneous reflection because of the metallic regions, which are strongly reflective as compared with the less reflective materials of the insulating regions.

FIG. 5 illustrates this phenomenon in a top view of two examples of areas illuminated by a laser beam of a sensor and the corresponding light intensity responses I. If the diameter of beam d1 is too large with respect to the minimum size of the patterns of the scanned object, the measurement risks being faulty, especially at the interfaces between regions having different reflections. In the example of FIG. 5, parallel lines 71, 72, and 73, strongly reflective with respect to a less reflective bottom 74 are assumed. With a spot of diameter d1, the response of the sensor which reproduces the reflection image in the direction of the CCD bar translates as three peaks er₇₁, er₇₂, and er₇₃ having different amplitudes. The zero intensity level is a mere convention, peaks er₇₁, er₇₂, and er₇₃ actually corresponding to peaks with respect to bottom reflection level er₇₄.

A triangulation sensor generally determines the position based on the barycenter of the received intensity or of the amplitude maximum. Accordingly, the position on the bar risks translating an erroneous elevation. Assuming an elevation z, barycenter BC is offset with respect to position z. A beam creating a spot having a diameter d of the same order of magnitude as the minimum size of the patterns on the object is thus preferably used. A single peak “er” is then present on the sensor response.

Further, a sensor resolution which is smaller (preferably, at least ten times smaller) than the depth of focus of the analysis microscope lens will be selected.

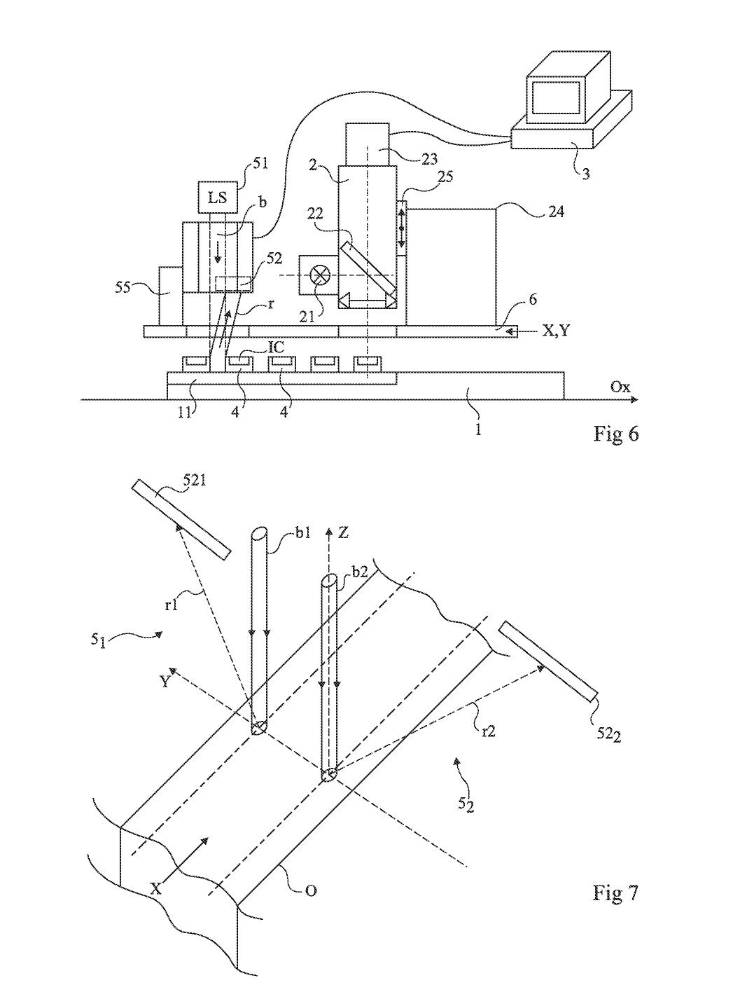

FIG. 6 very schematically shows an embodiment of an installation for taking images of electronic devices IC assembled in packages 4 by means of a reflection microscope 2. Several packages 4 are placed in a carriage 11 supported by conveyor 1. The conveyor is moved in a plane XY (generally horizontal) perpendicular to the optical axis of the microscope. As a variation, the position of the package is fixed and a plate 6 supporting microscope 2 is moved in plane XY to scan the objects to be processed. Usually, microscope 2 is equipped with a light source 21 directed, via a semi-reflective mirror 22, in the optical axis of the microscope. Each image is taken by a digital sensor 23 (for example, of charge transfer type) to be exploited by an image processing system 3 (for example, a computer). The head of microscope 2 is assembled on a support 24 and is vertically adjustable with respect to plate 6 by means of an adjustment device 25 (for example, mechanical) enabling the focusing.

According to this embodiment, the installation also comprises at least one triangulation sensor 5 supported (support 55) by plate 6. Preferably, the installation is equipped with two sensors 5 placed at a distance from each other.

FIG. 7 illustrates this preferred embodiment and shows two sensors 5₁ and 5₂ of the type in FIG. 4 facing a same object O. Assuming a line processing in a direction (for example, X) of plane XY, the two sensors are aligned in a perpendicular direction (axis Y) of the plane, that is, the emitted beams b1 and b2 are in a vertical plane parallel to axis Y while being normal to reference plane XY. Optical systems 53 have not been illustrated in FIG. 7.

During the displacement of conveyor 1, and thus of the circuit batch, each sensor 5₁ and 5₂ provides a set of measurement points from which the computer system extracts an elevation profile relative to a reference plane. The two obtained profiles are representative of the height variations of the object and are submitted to a digital processing to infer the attitude of circuit IC with respect to the reference plane. As a variation, the two profiles are obtained in two successive runs of a single sensor 5 at different positions along axis Y. The elevation of the reference plane is determined, for example in a calibration phase, as being the elevation of the bottom of cavity 41 of a package 4 or the conveyor level.

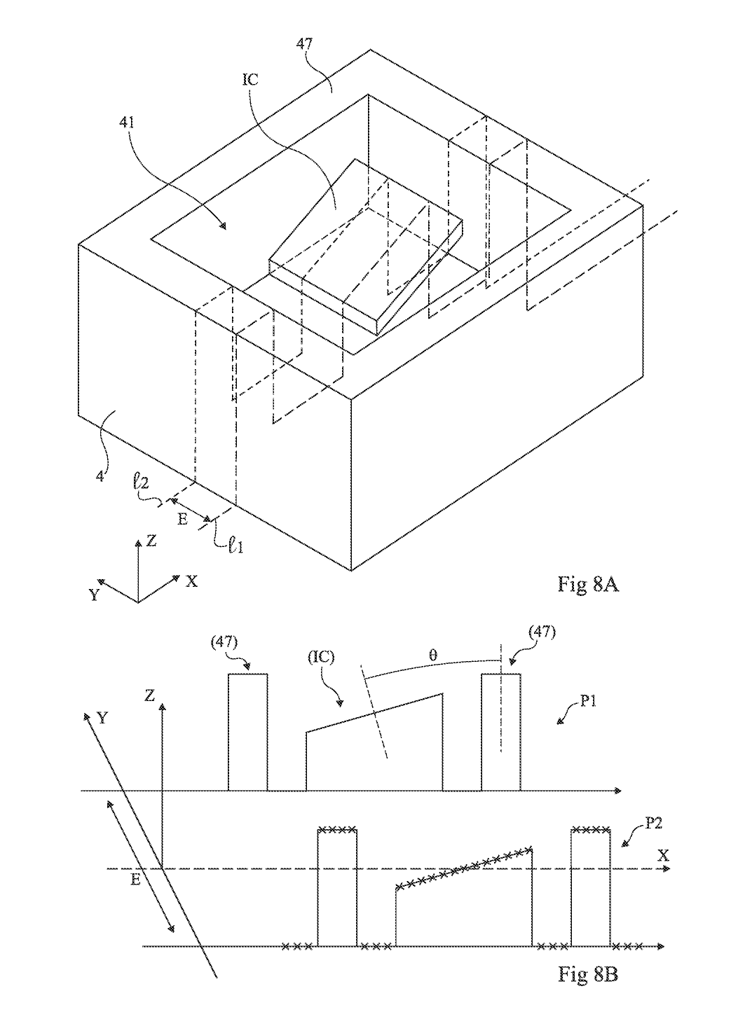

FIGS. 8A and 8B respectively show a simplified perspective view of a package 4 in which an integrated circuit chip IC has been assembled and the two profiles P1 and P2 obtained by means of sensors 5₁ and 5₂ of FIG. 6.

As illustrated in FIG. 8A, the relative displacement of package 4 with respect to sensors 5₁ and 5₂ is such that elevation measurements are performed by scanning along two lines 11 and 12 parallel to a first direction (axis X), distance E between the two lines in a second perpendicular direction (Y) of the horizontal plane being constant. The interpretation of the electric signals provided by sensors 5₁ and 5₂ provides the two profiles P1 and P2 (FIG. 8B) by interpolation of the measurement points (symbolized by crosses in profile P2). The interpretation of these profiles enables to determine the chip attitude with respect to the package plane. For example, a tilt angle Θ of each chip profile with respect to the vertical direction is determined. Knowing distance E between the two lines and angles Θ at the level of each of the profiles, the chip attitude can thus be determined by usual calculation tools. The abscissas (axis X) of the measurement points are extracted, for example, from data provided by a device for controlling the displacement of conveyor 1 with respect to a reference position. According to another example, doing away with displacement control inaccuracies, the abscissas are extracted from the profile images. For example, the edges representative of edges 47 of packages 4 are detected and, knowing the width of these edges, the coordinates to the chip areas are inferred therefrom. These coordinates are then used to only take views for locations above the chips.

According to an example of application, the maximum tilt of the chip (whatever its direction) is compared with an acceptable threshold for purposes of quality control of the generated circuits.

According to another example of application, the attitude is used to determine the respective elevations of the different areas A1 to A16 (FIG. 3) where images are taken (for example, the elevation at the center of each area) to set the focusing of the microscope for each area.

It could have been devised to calculate the respective elevations of the different areas one by one, by determining the respective coordinates of several points in each area. However, determining the chip attitude with exactly two parallel measurement lines saves time with respect to such a solution, due to a decrease in the number of necessary measurement points.

The accuracy of the obtained profiles of course depends on the number of measurement points per profile, but also on the diameter of the incident spot. If this diameter is greater than the roughness (vertically and in the plane) of the observed surfaces, the number of sampling points may be increased to compensate for a possible error equal to the diameter. If the spot diameter is smaller than the roughness, this error disappears.

Be it for reflection inhomogeneity or roughness problems, the spot diameter is selected according to the acceptable error for the measurements.

Referring to the specific dimensional example provided in relation with FIG. 2, a spot having a diameter of approximately 30 micrometers provides acceptable results.

FIG. 9 is a block diagram of successive steps of a process of image analysis by means of the installation of FIG. 6.

In a first step (block 81, TILT DETERM), the respective attitudes of the structures and more specifically of the chips to be analyzed are determined by scanning of the circuits in the line running direction (X).

In a second step (block 82, AREA SPLIT), the surface of each chip is split into imaging areas. The horizontal position of a chip may be determined based on the displacement speed of the conveyor. As a variation, advantage is taken of the obtained profiles to detect the respective positions of the chips.

Then, a second scanning is performed for the actual imaging (block 83, FOCUS AND IMAGE) by setting the microscope focusing according to the elevations determined for the different areas. The scanning is here generally in both direction X and Y of the plane (except for circuits which would be elongated and narrower than the microscope illumination area).

Finally, the obtained images are submitted to a processing (block 84, PROCESSING), which depends on the application of the installation. For example, these images are used to detect the presence of impurities on the chip surface.

An advantage of the described embodiments is the time it saves to focus the microscope due to the previous determination of the chip attitude. As a specific embodiment, the taking of 100 measurement points per profile along the chip length is sufficient to accurately determine the elevation and only takes a few tenths of a second.

Another advantage is that the attitude measurement has two uses. On the one hand, the focusing for the imaging and, on the other hand, the detection of defects of assembly of the chip in its package.

The described embodiments especially take advantage of the fact that the components to be examined are aligned in the described example (FIG. 6), which enables to measure the attitude of all chips in a single run. The fact of determining the attitude due to the two profiles for each component and of separately taking images enables to save time in the circuit analysis.

Another advantage of using scan beams normal to the reference plane is that it further makes the described method and installation compatible with the examination of a chip protected by a glass pane (glass thickness ranging from a few hundreds of micrometers to a few millimeters). The attitude determination is insensitive to the presence of this glass pane, since the attitude of the component placed in the cavity under the window can still be detected.

Different embodiments have been described. Various alterations and modifications will occur to those skilled in the art. In particular, the selection of the diameters of the spots of the triangulation sensors depends on the application.

Further, although the present invention has been more specifically described as combining the attitude determination with a focusing adjustment, it also applies to an installation in which only the triangulation sensor would be used to determine, by means of two parallel profiles, the attitude of micro-electronic chips or more generally of substantially planar objects.

Finally, the practical implementation of the invention based on the functional indications provided hereabove is within the abilities of those skilled in the art using current calculation and image processing tools.

1. A method of focusing, by an imaging device, of images of a substantially planar surface of an object, comprising the steps of:
determining the attitude of the surface of the object with respect to a reference plane by scanning this surface by means of at least one triangulation sensor along exactly two parallel lines in the reference plane;
splitting the surface of the object into areas of a size corresponding to the size of a taken image;
inferring from the attitude respective elevations of the image areas; and
adjusting, for each area, the focus with respect to the elevation thereof.

2. The method of claim 1, wherein the attitude is determined from two profiles representative of the elevations of the surface with respect to the reference plane.

3. The method of claim 1, wherein a laser beam of the sensor is normal to the reference plane.

4. The method of claim 1, wherein said lines are parallel to a direction of line processing of a batch of objects.

5. The method of claim 1, wherein the resolution of the sensor is selected to be smaller than the depth of focus of the imaging device.

6. The method of claim 1, wherein the diameter of the spot created by a laser beam of the sensor at the surface of the object is selected to be of the same order of magnitude as the smallest dimension of patterns on the object.

7. An object imaging installation for an analysis by image processing, comprising:
a reflection microscope with a settable depth of focus, equipped with a digital camera;
a conveyor of the objects in a reference plane perpendicular to the optical axis of the microscope;
a device for determining the attitude of each object with respect to the reference plane; and
a system for interpreting the attitude to focus said microscope, said installation being capable of implementing the method of claim 1.

8. The installation of claim 7, wherein the attitude determination device comprises two triangulation sensors aligned in a direction perpendicular to the scanning direction.
